(19) United States
(12) Patent Application Publication
(10) Pub. No.: US 2022/0147432 A1
(43) Pub. Date: May 12, 2022

(54) METHOD AND SYSTEM FOR INSTANT CONVERSATION ACHIEVEMENTS LABELING

(71) Applicant: Livechat Software S.A., Wroclaw (PL)

(72) Inventor: Krzysztof Górski, Wroclaw (PL)

(21) Appl. No.: 17/586,874

(22) Filed: Jan. 28, 2022

Related U.S. Application Data
(63) Continuation-in-part of application No. 16/258,784, filed on Jan. 28, 2019.

(51) Int. Cl. G06F 11/34; G06F 11/30; H04L 51/02

(52) U.S. Cl. CPC G06F 11/3452; G06F 11/302; H04L 51/02; G06F 11/3075

(57) ABSTRACT

An instant messaging and measuring instant communication effectiveness is set out. The disclosure is directed towards measuring the performance of the chat by chat goal that is a composition of metrics to be achieved during the conversation. The disclosure is directed to a system and method for chat communication evaluation in the form of achievements marking that are based on predefined conditions. The conditions are configured on the processor of the second user (also referred to as the chat operator) and are further transferred to the server for storage purposes. The goal is a composition of information collected by the system about the first user (end-user) as for example previously visited page, purchase, time spent on the page. Goal collection may be extended over time and interrupted by other events.

### CROSS-REFERENCE TO RELATED APPLICATIONS

This application is a Continuation in Part and claims the benefit of priority to pending U.S. patent application Ser. No. 16/258,784, filed Jan. 28, 2019, the content of which is herein incorporated by reference.

### BACKGROUND OF THE INVENTION

The present invention is directed towards instant communication channels, wherein one of the most important challenges is gathering data about a chat performance. Instant communication remains one of the most widely used customer support and service solutions today. Consequently, it is of importance for the chat operators to evaluate the effect of chat communication conducted between the end-user, also referred to as the visitor of the webpage, and the chat agent. Performing such measurements enables an evaluation of the business efficiency of the communication as well as helps to improve the functionality of the service.

Currently, available customer service tools fail to provide an easy and scalable process by which data collection be made that would fit individual business needs but with no need to develop custom-programmed solutions that will perform data collection for the beneficiary of such data (chat operator).

### BRIEF DESCRIPTION OF THE SEVERAL VIEWS OF DRAWING

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

FIG. 1 depicts a simplified version of an interaction between the first user processor, webpage, server, and second user processor.

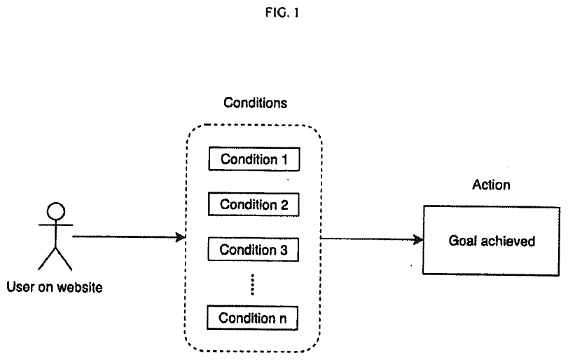

FIG. 2 depicts a chat widget and elements that may be used as triggering qualifiers included in the goal definition.

FIG. 3 depicts the goal configuration interface on the processor of the second user in the agent application with URL elements configured.

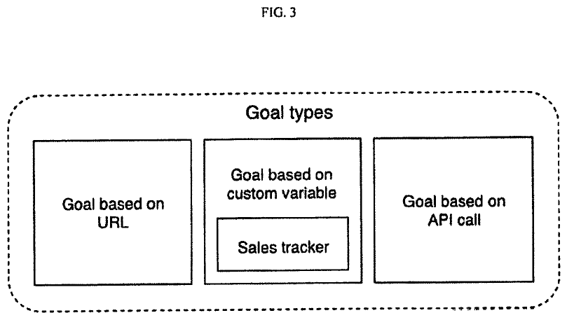

FIG. 4 depicts the flow while the first user performs the action on the webpage that is further defined as one of a number of goal conditions.

FIG. 5 depicts a simplified version of interaction between the first user and the goal achieved state with a plurality of goal conditions indicated.

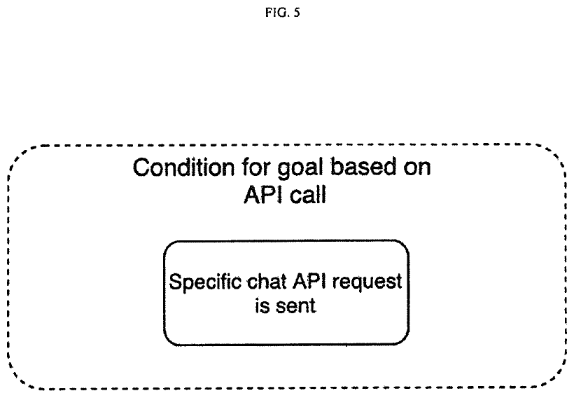

FIG. 6 depicts a goal configuration interface on the processor of the second user in the agent application with sign up forms being custom variable.

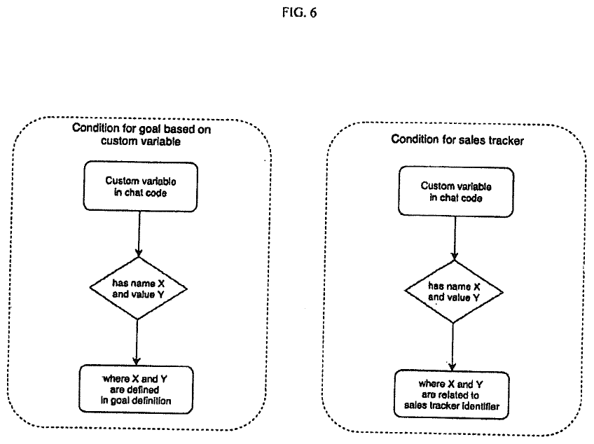

FIG. 7 depicts a flow of interaction between the first user and elements of the infrastructure checking if the goal has been achieved including the option of goal set up in the database and no goal set up in the database.

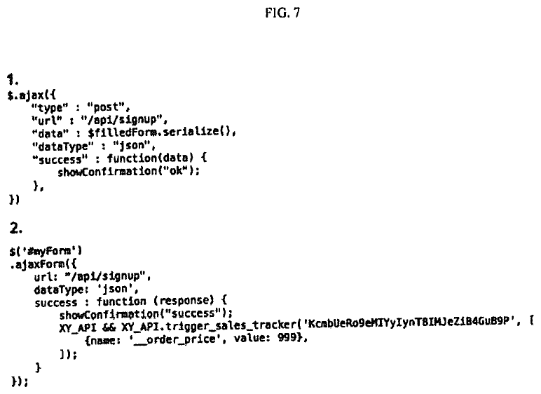

### DETAILED DESCRIPTION OF THE INVENTION

The disclosure of the invention provides both frontend and backend elements of the infrastructure that further comprises the goal set up, collection of the data about the user activity on a website, and comparison of the collected result with the goal. The disclosed invention is composed out of the system that includes an API infrastructure that communicates with the chat channels, a server that hosts the database with the predefined conditions for goal classification and logic that triggers goal collection, and a second user processor that enables goal creation from the user interface and displays collected goals in communication with the server. The disclosed invention also provides method steps that facilitate the steps of the goal set up and collection.

The present invention is directed to a system and method for chat communication evaluation in the form of achievements marking named goals that are based on predefined conditions. The conditions are configured on the processor of the second user (also referred to as the chat operator) and are further transferred to the server for storage purposes. The goal is a composition of information collected by the system about the first user (end-user). Each goal may be composed out of at least one parameter that is further collected by the system. The process of data collection starts with the first user (101) that performs some actions on the webpage (102). The actions performed by the first user (101) are further transferred to the storage server (103) where the elements of the system as a database of triggering module are hosted. It is then further sent to display to the second user processor where the agent application is configured (104). The server (103) and second user processor (104) communicate with each other over the network. The chat operator can configure the goal definition on the second user processor (104) by the agent application.

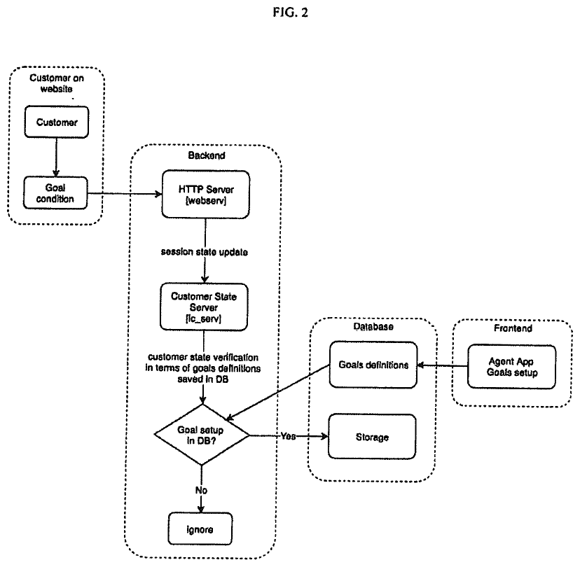

Triggers that lead to an achieved goal may be collected from multiple sources on the webpage with chat widget installed. The first user interacts with the chat widget, as disclosed FIG. 2, the interaction possibly given rise to the triggers of goal collection by the disclosed system and method. In the case of chat widget, the user can send the content (201) to the chat operator, upload an image (203) or send the attachment (202). Chat widget further displays the content sent by both chat operator and end-user in the form of a thread with timestamp (205). All of the listed actions may possibly be set up as triggers to achieve the goal.

The processor of the first user is configured to generate goals that are based on the conditions as disclosed below:

Static—count goal achievement that is based on the number of certain actions. Regardless of the purchase value, the chat will be credited the same, set amount every time. It is based upon a simple sum of elements that have been purchased and the rule that every purchase is worth the same.

Dynamic—a method designed to provide a monetary assessment based on the value of the purchase by the end-user. This method shall be especially practical once implemented in the e-commerce cart after purchase.

Non-Monetary—used to assess goal collection based not on the value of object but on the fact of sale, such method may be applied in case of conversion of customers, for example in case of Software as a Service (SaaS) companies.

Goal configuration includes selection of enabled triggers via the user interface and adding such triggers as the elements of the goal achieved definition. This configuration is enabled on the processor of the second user (chat operator). It is, for example, possible to configure the goal based on the successful purchase (301) also adding the condition that the user previously visited the exact page with detailed URL information (302). After this selection the chat operator can create a goal (303).

An example of such a goal may be detailed further to include as a goal achieved if the end-user enters a page www.examplepage.com/sale, clicks on the button “Cart”, and places an order of a value over 100 USD. This example shows a complex goal including a definition of static goal (the user enters the page), combined with dynamic including the expected value of the order. The element of clicking button “cart” may be that information is transferred by the API of the eCommerce store to the system disclosed by the present invention. In such a case, the described goal includes a definition of goal that, to be completed, requires information about a click received from the API. On the other hand, goal achievement may include only a simple requirement of action with no evaluation of the monetary result, for example, the fact of purchase. The chat operator may create a goal that requires that the end-user enters the page www.examplepage.com/sale and purchases a product. The value of the product is irrelevant in the case of this goal achievement measurement. In such a case, the non-monetary element of goal definition is used.

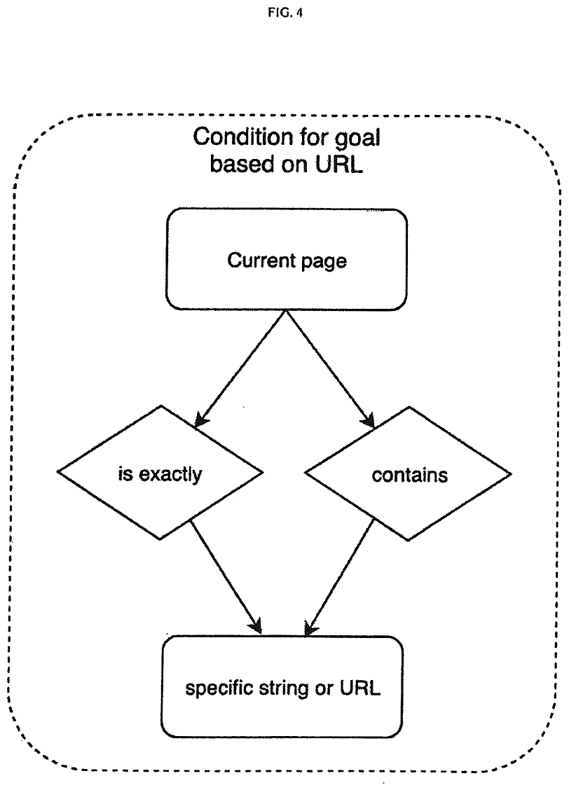

Goals are composed as a collection of results concerning actions of the first user that shall be further compared with the data about the user as disclosed by FIG. 4. The system collects the information about the first users (401) activity on the webpage (402), saves it into the database located on server (407), and then checks if the action performed matches the pattern. If the performed action matches the pattern, then the goal is achieved (408). The action performed by the first user (401) on the webpage (403), as for example clicking the button (405), further leads to the goal being achieved (408). Achievement of the goal is determined by the triggering module (407) configured on the server.

Goal definition (502) may be a composition of a plurality of the conditions that will be compared with the action of the first user (501). There is no limitation on the number of conditions for the goal to be achieved (502). Each parameter collected by the database may be considered independently and the system and method steps are directed towards the check of a practical outcome (503) of the action, not the sequence. Consequently, the goal definition may indicate that in case of such a sequence: the user enters the page www.examplepage.com/sale, opens the first item, closes the item, opens the second item, and purchases, the goal is achieved. The fact that the sequence of required conditions for the goal achievement is interrupted by other actions as closing the first item and opening the second one does not interfere with the goal measuring process or goal being marked as achieved.

Non-monetary goal measures may further include custom variables including API calls. In such a case, the system is enabled to create a goal-based upon a precise parameter received via API. For example, an instant communication channel provider enables sign-up forms (603). The chat operator creates a goal that requires checking if the sign-up form was filled up by the end-user by the option of custom variable (601). In such a case, the chat operator set up a goal of a definition including the name of the parameter signup_form and the value denoting the effect of the signup form, for example value=1 (602). Similarly, to this, the goal may include a definition of marking this goal as achieved when the API request is sent. In such a case, the mechanism will mark the goal as achieved once any API request of a defined type is being or has been sent. For example, the goal is marked as complete when a call is scheduled via the external calls scheduling tool.

Checking if the goal has been achieved is a repetitive action. The method steps begin with the website (701) where the end-user on the website (702) performs the action that constitutes a goal condition (703). The system checks new, incoming data arising from the website (701) to the backend infrastructure (705) configured on the server and matches the pattern included as a goal definition (714). This process is repetitive so as to enable the checking of parameters of the goal over and with the other events interrupting the sequence. The process of communication between Website (701) and backend infrastructure (705) on the server happens over HTTPS (707). After the data from the website comes into the server, the session is updated (710) and the system checks (711) if there is a goal that may match with the incoming data. If there is no goal set in the database, (708) there is no further action, and further processing is ignored (712). If there is a goal set up in the database (709) then the incoming data saved in the storage (715) is compared with the goal definition (714) and the result, as well as individual records, are saved in the database (713). The result is also further displayed on the processor of the second user with an agent application installed (716).

Chat operators may schedule if the goal is collected in a repetitive manner, which means that after the goal is achieved for the first time, the system collects the information that the achievement of the goal happened again or that the goal can be completed only once.

The disclosed invention may operate on both web pages and online applications (operating through browsers) where the chat widget is installed. Furthermore, the invention shall be comparable with all types of online instant communication that enables API access. The website with embedded chat widget may include one or more Web servers that accept HTTP requests from clients, such as web browsers, and server HTTP responses in addition to optional data contents, such as web pages (e.g., HTML documents and linked objects, such as images), that receive user inputs. The database is in a real-time processing relation that shall provide no communication delays between a factual goal occurring and a goal scored detection.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A system for instant conversation goals measuring, the system comprising:
a chat widget arranged on the processor of the first user and configured to communicate with the server;
a server arranged in a cloud environment and configured to store data about the (?) goal;
an agent application arranged to operate on the processor of the second user and configured to communicate with the server and first processor over the network; and
wherein the store data further comprises a goal definition, triggering qualifiers and a goal achieved log.

2. The system according to claim 1, wherein the chat widget further comprises:
data input configured to accept alphanumeric content, images, and voice messages;
attachments input configured to accept files;
a communication thread configured to display timestamps of thread according to the date and time; and
wherein the chat widget communicates with the server and the agent application over the network.

3. The system according to claim 1, wherein the server further comprises:
a database configured to store data regarding goals;
a triggering module arranged to receive API calls and webhooks from the chat widget regarding the incoming data;
a statistics module arranged to collect the data from the database and send it to the agent application to display the goal achievement log; and
wherein the triggering module is configured to store at least one triggering qualifier which enables determining of the goal classification, and
wherein the database is configured to store an indication of whether the goal has been achieved based upon the at least one triggering qualifier.

4. The system according to claim 1, wherein the agent application further comprises:
an API configured to communicate with the server;
a goal creator configured to set up the goal definition;
a data display configured to display goal achievement log; and
wherein the API is further configured to handle webhooks.

5. The system according to claim 3, wherein the database further comprises:
a goal definition storage configured to store data regarding components of a goal definition;
a goal achievement log configured to store data regarding goals achieved by the first user; and
wherein the goal achievement log is further configured to store data about an unmet goal for statistical purposes.

6. A method of measuring instant conversation goals, the method comprising the steps of:
classifying the at least one goal;
establishing at least one triggering qualifier which enables determination of a goal classification,
determining a goal to be achieved;
determining whether the goal has been achieved based upon the at least one triggering qualifier;
if a goal has been achieved, determining a classification of the goal that has been achieved and storing into a database the goal to be achieved, an indication of whether the goal has been achieved, and the classification of the goal that has been achieved;
collecting data in a backend structure based upon the classification, and displaying the data through a frontend interface;
collecting information through an independent networked system communicating via at least one of an HTTP protocol, API call, URL, custom variables, and code installed in a web page structure, the information including data regarding at least one of user interactions and user behavior; and
wherein at least one triggering qualifier is based upon at least one of the HTTP protocol, the API call, the URL, the custom variables with HTTP server and code; and
wherein the step of determining whether the goal has been achieved is repeated until it is determined that the goal has been achieved.

7. The method according to claim 6, wherein:
the collected data comprises chat code; and
a custom variable may include a chat effectiveness assessment constructed upon at least one visitor reaction and conversion upon interaction with an agent through chat.

8. The method according to claim 6, further comprising the steps of:
defining a collection of data based upon an aggregation of the determination of a goal to be achieved, the determination of whether the goal has been achieved, and the determination of a classification of the goal;
defining a subset of the at least one visitor which meets a criterion set up in the database;
providing the collection of data filtered according to at least one of the subset of the at least one visitor in case of a positive fulfilment of the goal based upon triggering qualifiers and an action dropped in case of a mismatch between data collected and related goals;
containing a channel which ensures communication between the frontend and the backend and a functional API which communicates an embodiment with external applications;
receiving initial data indicating which of the at least one visitor registered action via the website during the first period of time; and
associating the initial data with a scoring system.

9. The method according to claim 8, further comprising the steps of:
determining whether receiving new data was received;
if the new data was received:
i. collecting the new data in a backend structure;
ii. updating the results based upon the collected new data;
iii. displaying the new data through a frontend interface; and
wherein, the new data is received from at least one of the HTTP protocol, the API call, the URL and the custom variables.

10. The method according to claim 8, further comprising the steps of:
creating a definition of a goal based on at least one triggering qualifier;
creating a timestamp for every triggering qualifier when at least one triggering qualifier is applied;
creating a timestamp for every time at least one goal is saved in the database;
providing the collection of data filtered according to a timestamp saved in the database; and
displaying over time a positive fulfilment of the goal based upon triggering qualifiers and an action dropped in case of a mismatch between data collected and related goals.

11. The method according to claim 8, wherein the database is an online database configured to be directly accessible by the backend structure.

12. method according to claim 8, wherein collecting of data from external sources available via URL is enabled by using an analysis of aliases of query strings included in the URL.

13. The method according to claim 8, wherein the step of reporting into the database further comprises the step of reporting into the data via a backend structure.
